(19) United States
(12) Patent Application Publication
(10) Pub. No.: US 2007/0017066 A1
(43) Pub. Date: Jan. 25, 2007

(54) Overmolding organic objects

(75) Inventors: Kaisern Chen, Bangkok (TH); Prompong Hakk, Bangkok (TH)

Correspondence Address: BARNES & THORNBURG LLP, P.O. BOX 2786, CHICAGO, IL, 60690-2786, US

(73) Assignee: SOTA BITI CORP.

(21) Appl. No.: 11/184,577

(22) Filed: Jul. 19, 2005

(51) Int. Cl. B25G 1/10

(52) U.S. Cl. 16/421

(57) ABSTRACT

Items with real natural or organic objects encased in clear, translucent or lightly tinted thermoplastic or thermo-rubber materials, which encapsulate and protect the objects inside from air, water or other environmental factors. A structure can be over-molded with thermoplastic or thermo-rubber material, preferably elastic silicone. Over-molding or encasing real natural objects in such materials aims to merge natural objects with functional kitchen utensils or similar household items. Visible through the encapsulating media, natural objects will keep their stunning looks as they are preserved for long lasting enjoyment. Natural objects can be encapsulated in between two gummy thermo-rubber sheets in airtight overmolding. Also, pre-molded pieces with shaped cavities for the natural objects can be secured together after natural objects are inserted in the cavity. Natural objects may be encased in a cavity of two or more already pre-molded pieces.

### BACKGROUND

The present disclosure relates to utensils or similar items with real natural or organic objects overmolded or encased in thermoplastic or thermo-rubber materials, which encapsulate and protect the objects inside from air, water or other environmental factors. The disclosure also describes methods of making such items.

Nature has always been a popular icon for household items. The kitchen remains a popular spot where we use natural ingredients to cook and prepare fine meals. As such, utensils or similar items often seek to integrate such natural objects. However, most reproductions of nature remain two dimensional or synthetic since real natural objects have special considerations making it obviously harder to include such objects into household items. So how does one bring life into a lifeless object? The challenge was to find a way to preserve nature's preciousness while merging real natural objects with items that withstand the abuses of household use.

Available household and industrial products have not yet found the way to merge with true nature while remaining suitable for their function. The compromise of synthetic material as replicas of natural objects only results in false impressions of nature's true beauty.

Also, many products do not take full advantage of the superb characteristics of thermoplastics or thermo-rubber. Thermoplastic or thermo-rubber materials, such as silicone, are excellent for handles because of their slip-proof nature, gripability, and thermal and chemical characteristics. But these materials can also preserve real natural objects incorporated into functional items.

U.S. Pat. No. 6,189,540 discloses a hair styling comb with a layer of resilient material overmolded on a core member. It does not disclose encasing natural or organic objects.

Thus, it is desirable to produce items with real natural objects encased in thermoplastic or thermo-rubber materials.

### SUMMARY

The present disclosure describes items having real natural or organic objects encased in thermoplastic or thermo-rubber materials. Overmolding and encasing real natural objects in thermoplastic or thermo-rubber materials aim to merge natural life symbols and objects with functional kitchen utensils or similar household items. The materials can include clear, translucent or lightly tinted thermoplastic or thermo-rubber materials, such as silicone, to encapsulate and protect the objects inside from air, water or other environmental factors, allowing the enjoyment of the encapsulated objects' natural beauty for a long time. Utensils or similar items with real natural or organic objects encased in thermoplastic or thermo-rubber materials may remain functional while capitalizing on the natural beauty of nature.

The characteristics of silicone are kitchen-friendly and are appropriate for encasing real natural or organic objects:
Odorless
Non-toxic
Non-irritating to user's hands and eyes
Will not scratch surfaces on contact
Provides slip-proof function
Has good grip feel to provide efficient hold
Resistant to a wide range of pH level chemicals around the kitchen i.e. vinegar, pickles, salt, oil and grease
Physiochemical inertness
Resistant to thermal influences from cold or hot
Consistent behavior under heat and thermal shock
Withstands heat up to 600° F./315° C. for reliable safety and function
Moldable as clear, semi-transparent, translucent, tinted or colored
Can provide airtight, leak-proof seal
Long life span and lasting appearance

A variety of real natural objects can be encased in items. Cooking ingredients may include dried spices, peppers, citrus or pasta. Agricultural objects may include coffee beans, corn, wheat, and tea leaves. Landscape objects may include flower blossoms, petals, minerals and crystals.

Nature can be merged with contemporary household products to replace lifeless artificial replicas of nature that disgrace nature's true beauty. Fake applications with their audacious and boring looks may become obsolete because nature is absolute and timeless. By encasing or overmolding natural objects, like cooking spices (dried out pepper, lime, chilies etc.) or coffee beans, with food grade silicone, these methods preserve natural objects from wear and decay. Clearly visible through the encapsulating media, natural objects will keep their stunning looks as they are preserved for long lasting enjoyment. In addition, silicone provides excellent characteristics for daily use by people like grip comfort, slip-proof and flexibility.

A first way to successfully merge nature with functional items is airtight overmolding, which is a process where the natural object is directly encapsulated between two gummy thermo-rubber sheets. The object is totally preserved from the outside in a fixed state with no movement.

Another way to successfully merge nature with functional items is combination molding, which allows a much more advanced assembly of natural or organic objects. It includes a two-step process where one half of the overmold is premolded to shape cavities for the natural objects. This overmold tolerates complex forms of geometric or organic roots and can be applied to thermoplastics as well as thermo-rubbers. Once the first half is done, the prepared cavities are filled with the applicable natural objects and then returned to the machine for the second overmold step, which will seal the natural objects. The second overmold carries the same characteristics as the first overmold. Combination molding may also include the use of other materials, such as ferrous & non-ferrous metals/alloys or ceramics/glass, to form the first mold half. After the second overmold is merged with the first one, the objects encased are safe against any physical battering and kept locked into position without any movement.

A third way to successfully merge nature with functional products is encasing, which is a manufacturing process where the natural objects may be stored in a cavity of two or more already premolded pieces. The pieces or halves are secured and merged together by ultrasonic means, adhesive, mechanical lock or heat sealing. Products made by this process permit the encased objects either free or restricted movement within the encapsulated space while they are still kept safe from damage from outside the encasement.

These methods of encasing real natural or organic objects can be used to make functional handles, grips and knobs for kitchen utensils, tools, cookware, tableware, serving containers, mugs, and doors. Other items using these methods include cutting boards, coasters, mousepads, floormats, and placemats. Items with real natural objects encased in durable thermoplastic or thermo-rubber materials will have objects inside protected from outside factors for long lasting enjoyment.

### BRIEF DESCRIPTION OF THE DRAWINGS

The features of this disclosure and the manner of obtaining them will become more apparent, and the disclosure itself will be best understood by reference to the following description of embodiments of items including real natural or organic objects encased in thermoplastic or thermo-rubber materials taken in conjunction with the accompanying drawings showing particular embodiments of the items and methods, wherein:

FIG. 1 shows a perspective view of an item with a natural object encased in the handle;

FIG. 2 shows a cover, piece or layer that forms half of an encasement;

FIG. 3 shows a perspective view of an item with a natural object encased in the handle of a mug;

FIG. 4 shows a perspective view of one utensil with a natural object encased in the handle;

FIG. 5 shows a handle with one piece clear and another piece as a colored base;

FIG. 6 shows a handle having numerous natural objects;

FIG. 7 shows a handle being several pieces;

FIG. 8 shows an alternative design in a recess near a rim; and

FIG. 9 shows a handle having the natural object forming a portion to a provide grip for the user's thumb on the handle.

### DETAILED DESCRIPTION

While the present invention will be fully described hereinafter with reference to the accompanying drawings, in which particular embodiments are shown, it is to be understood at the outset that persons skilled in the art may modify the embodiments disclosed herein while still achieving the desired result. Accordingly, the description that follows is to be understood as a broad informative disclosure directed to persons skilled in the appropriate art and not as limitations of the present disclosure.

FIG. 1 shows an item 10 having a handle 12 with a real natural object 14 encased in a thermoplastic or thermo-rubber material 16. The material 16 may be two layers or pieces 18 and 20 that encapsulate and protect the encased object 14 from air, water or other environmental factors.

Thermoplastic or thermo-rubber materials, such as silicone, are excellent for handles because of their slip-proof nature, gripability, and thermal and chemical characteristics. The materials can be clear, translucent or lightly tinted thermoplastic or thermo-rubber material, such as silicone, to encapsulate and protect the objects 14 inside from air, water or other environmental factors. Pure silicone has excellent thermal and chemical properties. The preferred material 16 is a high grade elastic silicone that withstands heat up to at least 600° F./315° C. Ideally, the material 16 is clear food grade silicone.

As shown in the FIG. 1, a coffee bean is the object 14 sealed in the handle 12 of an item 10, shown as a coffee scoop, but it is also suitable that such a natural object 14 can be hermetically molded between layers 18 and 20. In either case, the natural object 14 is completely encased in thermoplastic or thermo-rubber materials 16. In FIG. 1, specifically, the natural object 14 is a coffee bean sealed in the handle 12 of the coffee scoop. The handle 12 of the coffee scoop as shown has a looped wire core 23 that is encased in the material 16, wherein the object 14 is surrounded by the looped wire core 23, but the looped wire core 23 does not penetrate the cavity 22.

FIG. 2 shows a layer or overmold piece 18 of material 16 having an optional cavity 22 for holding the natural object 14 and a preformed channel 24 to accept the looped wire core 23 of the handle 12. Layer 18 may be secured to a complementary layer 20, possibly as a flat piece or possibly also having a cavity and/or a channel (as a mirror image of FIG. 2), that encases the object 14 and covers the handle 12.

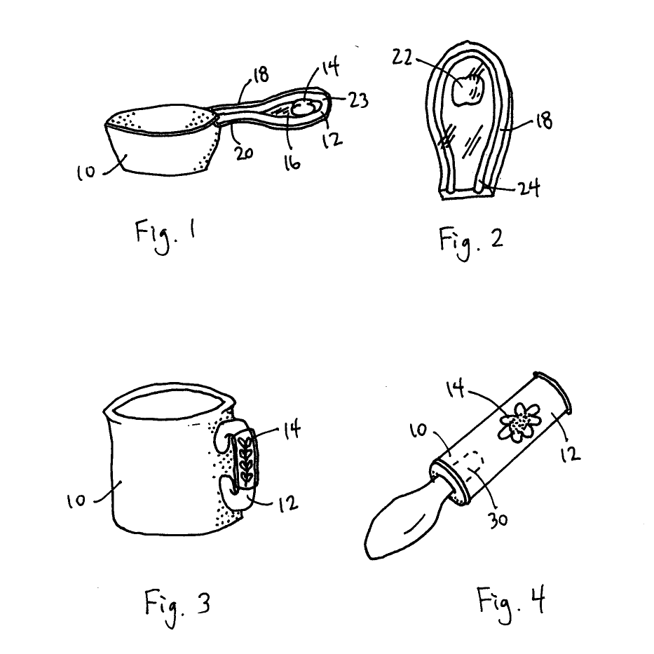

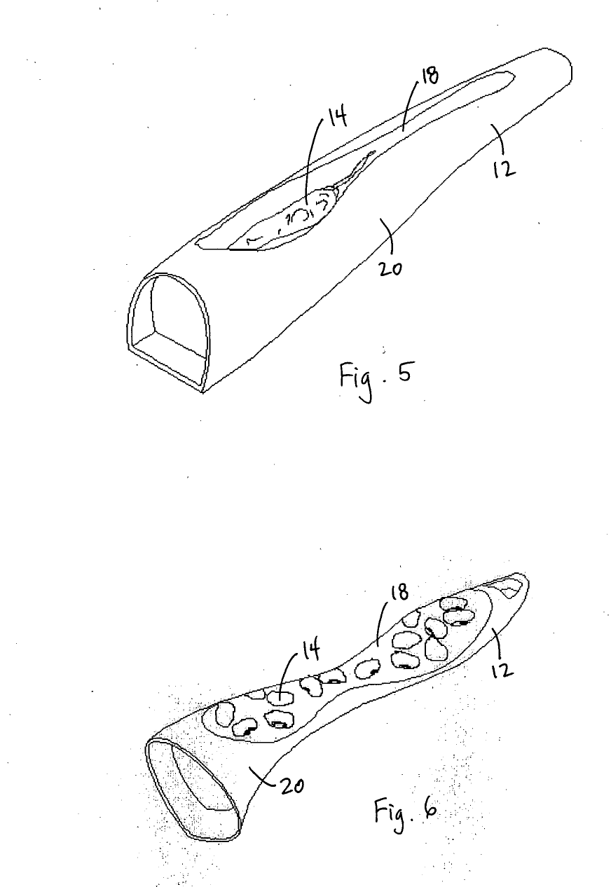

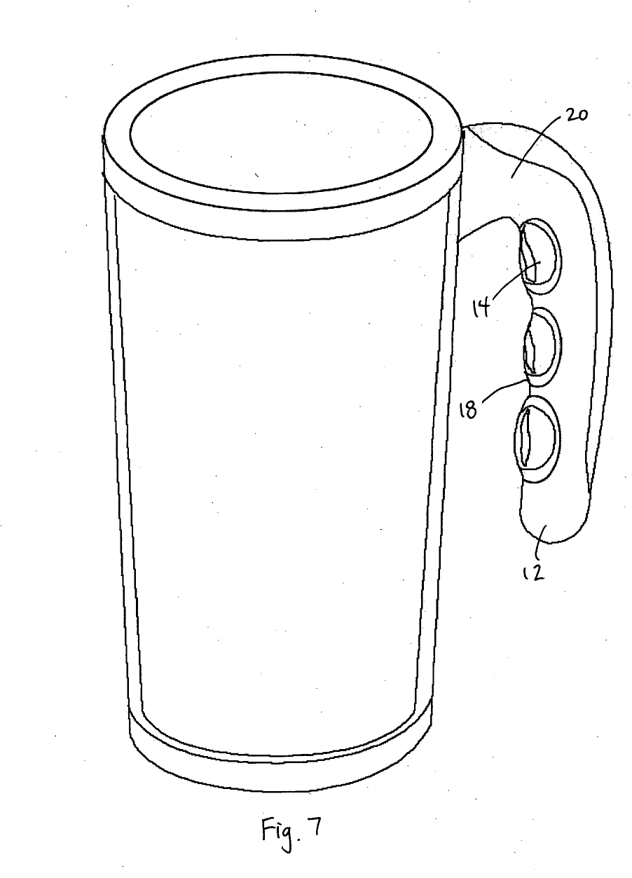

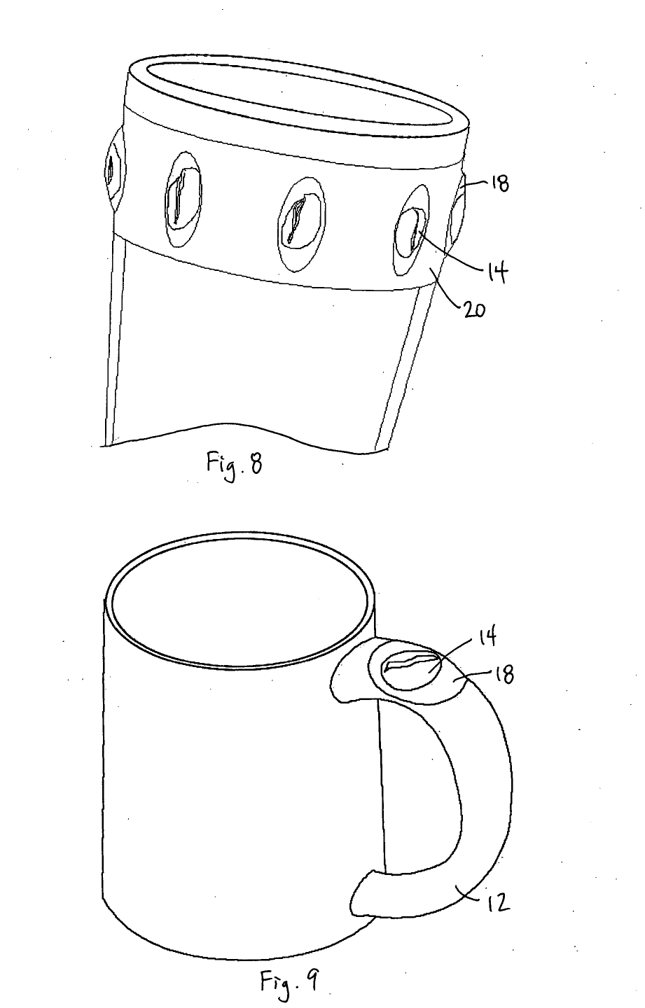

FIG. 3 shows a handle 12 having a natural object 14, such as a leaves, encased between the handle 12 and a layer 18 of thermoplastic or thermo-rubber material 16. FIG. 4 shows a utensil 10 having a handle 12 with a natural object 14 as part of the handle 12 wherein the natural object 14 is completely encased in a material. The thicker handle 12 can be formed of two overmolds merged together. A core 30 that is a shaft extends into and is encased by the material 16. FIG. 5 shows a handle having a dried bean as the natural object 14 with piece 18 being clear, and piece 20 as a colored base. FIG. 6 shows a handle having numerous beans as the natural object 14 with piece 18 being clear, and piece 20 being translucent but tinted. As apparent, the pieces can be any combination of clear, tinted or colored. FIG. 7 shows a handle having a coffee bean as the natural object 14 with piece 18 being clear, and piece 20 being several pieces. In FIG. 7, the coffee bean as the natural object 14 forms a raised portion to provide finger grips on the handle. FIG. 8 shows an alternative design where the two layers or pieces 18 and 20 that encapsulate the object 14 are laid in a recess near the rim of a cup or container. FIG. 9 shows a handle having a coffee bean as the natural object 14 forming a portion to provide a grip for the user's thumb on the handle.

In various embodiments, the layer or piece 18 may be considered the top as closest to the viewer's eye and may be clear, and the layer or piece 20 may be translucent and lightly tinted to complement the natural object 14. For example, for a coffee bean as the natural object 14, layer or piece 20, if farthest from the viewer's eye, could be tinted light brown.

Several methods of encasing real natural objects 14 in thermoplastic or thermo-rubber materials 16 can be used to make functional handles, grips and knobs or other items.

Overmolding includes a process where the natural object 14 can be directly encapsulated between two gummy thermo-rubber sheets, such as 18 and 20. The natural object 14 is totally preserved from the outside in a fixed state with no movement of the object 14. The method includes situating an item 10 or a portion of an item, such as a handle 12, along with natural objects 14. A method of making a utensil 10 with a natural object 14 encased in a handle 12 of the utensil 10 includes obtaining the natural object 14 and obtaining the handle 12 with a core, such as loop 23 or shaft 30. Heat is applied to a first and a second thermo-rubber sheet 18 and 20 so the sheets 18 and 20 become gummy. The first and the second gummy thermo-rubber sheets 18 and 20 can be secured together to completely encapsulate in an airtight manner the natural object 14 between the first and second gummy thermo-rubber sheets 18 and 20 and to encase a portion of the shaft 23 or 30 of the handle 12 to preserve the natural object 14 in a fixed state from outside exposure. The natural object 14 can be initially adhered to the first gummy thermo-rubber sheet 18 before the first gummy thermo-rubber sheet 18 is secured together with the second gummy thermo-rubber sheet 20.

Combination molding allows a more advanced assembly of natural objects 14. It includes a two-step process where one half of the overmold piece 18 is premolded to shaped cavities (i.e. 22) for the natural objects 14. This overmold tolerates complex forms of geometric or organic roots, and can be applied to thermoplastics as well as thermo-rubbers. Once the first portion is done, the prepared cavities 22 are filled with the applicable natural objects 14 and then returned to the machine for the second overmold step, which will seal the natural objects 14. The second overmold piece 20 carries the same characteristics as the first overmold piece 18 and preferably is the same material. Combination molding may also include the use of other materials, such as ferrous & non-ferrous metals/alloys or ceramics/glass, to form the first mold half. After the second overmold piece 20 is merged with the first piece 18, the objects 14 encased are safe against any physical battering and kept secured into position without any movement.

A method of making a utensil 10 with a natural object 14 encased in the utensil 10 may include premolding a first thermoplastic overmold piece 18 with a shaped cavity 22 that is compatible with the natural object 14. The natural object 14 is inserted into the shaped cavity 22. The second thermoplastic piece 20 is secured to the first thermoplastic overmold piece 18 to completely encase the natural object 14 within the first and second pieces 18 and 20. The second piece 20 can be flat or it can be premolded with a shaped cavity 22 (mirror image of FIG. 2) that forms an encapsulated space with the shaped cavity 22 of the first thermoplastic overmold piece 18 so that the natural object 14 has free movement within the encapsulated space formed by the cavities 22.

Encasing objects 14 in a cavity 22 is a manufacturing process where the natural objects 14 may be stored in a cavity 22 of two or more already premolded pieces 18 and 20. The pieces or halves (i.e. 18 and 20) can be secured and merged together by ultrasonic means, adhesive, mechanical lock or heat sealing. Items 10 made by this process permit the encased objects 14 free or restricted movement within the encapsulated space while they are still kept safe from outside harm.

The natural objects can correspond to the product. For example, coffee beans can be used with coffee mugs, coffee cups, coffee carafes, coffee servers, coffee sets, coffee scoops, and coffee presses. Similarly, tea leaves can be used with tea services sets and handles on tea kettles. Grass, leaves and petals can be used with garden tools and other theme items, such as door knobs, coasters and mouse pads.

Although preferred methods and embodiments are illustrated and described in connection with particular steps and features, they can be adapted for use with a wide variety of items and methods. Other embodiments and equivalents of the items and related methods of making those items are envisioned within the scope of the claims. Various features of the disclosure have been particularly shown and described in connection with illustrated embodiments. However, it must be understood that the particular examples merely illustrate and that the invention is to be given its fullest interpretation within the terms of the claims.

What is claimed is:

1. A utensil having a handle with a natural object as part of the handle and the natural object is completely encased in a material selected from a group of thermoplastic or thermo-rubber materials, the natural object overmolded airtight between pieces of the material.

2. The utensil of claim 1 wherein the material is elastic silicone.

3. The utensil of claim 2 wherein the elastic silicone is food grade elastic silicone that withstands heat up to at least about 600° F.

4. The utensil of claim 1 wherein the pieces are layers wherein one layer is clear and one layer is tinted.

5. The utensil of claim 1 wherein a first piece is shaped with a cavity that is compatible with the real natural object, the first piece is molded to a second piece with the natural object between the first piece and the second piece.

6. The utensil of claim 5 wherein the first piece that is shaped with a cavity is tinted and the second piece is clear.

7. The utensil of claim 5 wherein the first piece that is shaped with a cavity is colored and the second piece is clear.

8. The utensil of claim 5 wherein the first piece that is shaped with a cavity is colored and the second piece is tinted.

9. The utensil of claim 1 wherein the encased natural object forms a raised portion to serve as a finger grip on the handle.

10. The utensil of claim 1 wherein the utensil is a coffee scoop and the natural object is a coffee bean in a cavity of the handle of the coffee scoop, the handle of the coffee scoop having a looped wire core that is encased in the material, wherein the cavity is surrounded by the looped wire core and the looped wire core does not penetrate the cavity.

11. A method of making a utensil with a real natural object encased in a handle of the utensil comprising the steps of:
obtaining the real natural object;
obtaining the handle with a shaft;
applying heat to a first and a second thermo-rubber sheet so the sheets become gummy;
securing together the first and the second gummy thermo-rubber sheets to completely encapsulate in an airtight manner the real natural object between the first and second gummy thermo-rubber sheets and to encase a portion of the shaft of the handle to preserve the real natural object in a fixed state from outside exposure.

12. The method of claim 11 wherein the real natural object is initially adhered to the first gummy thermo-rubber sheet before the first gummy thermo-rubber sheet is secured together with the second gummy thermo-rubber sheet.

13. The method of claim 11 wherein the first gummy thermo-rubber sheet is clear and the second gummy thermo-rubber sheet is tinted.

14. The method of claim 11 wherein the first gummy thermo-rubber sheet is clear and the second gummy thermo-rubber sheet is colored.

15. The method of claim 11 wherein the first gummy thermo-rubber sheet is tinted and the second gummy thermo-rubber sheet is colored.

16. A method of making a utensil with a real natural object encased in the utensil comprising the steps of:
premolding a first thermoplastic overmold piece with a shaped cavity that is compatible with the real natural object;
inserting the real natural object into the shaped cavity;
securing a second thermoplastic piece to the first thermoplastic overmold piece to completely encase the real natural object within the first and second pieces.

17. The method of claim 16 wherein the first thermoplastic overmold piece is the same material as the second thermoplastic piece.

18. The method of claim 16 wherein the second thermoplastic piece is also premolded with a shaped cavity that forms an encapsulated space with the shaped cavity of the first thermoplastic overmold piece so that the real natural object has free movement within the encapsulated space.

19. The method of claim 16 wherein the first thermoplastic overmold piece is tinted.

20. The method of claim 16 wherein the first thermoplastic overmold piece is colored and the second piece is clear.
